(19) United States
(12) Patent Application Publication
(10) Pub. No.: US 2024/0393003 A1
(43) Pub. Date: Nov. 28, 2024

(54) FILTER SEALING COVER

(71) Applicant: Spencer Douglas, Windsor, CT (US)

(72) Inventor: Spencer Douglas, Windsor, CT (US)

(21) Appl. No.: 18/322,759

(22) Filed: May 24, 2023

(51) Int. Cl. F24F 13/20; B01D 46/00; B01D 46/88; F24F 8/108

(52) U.S. Cl. CPC F24F 13/20; B01D 46/0004; B01D 46/88; F24F 8/108; B01D 2271/02; B01D 2279/35; B01D 2279/50

(57) ABSTRACT

The present application relates to a filter sealing cover, the filter sealing cover comprises a sheet of impermeable material, a zipper and a bonding layer. The filter sealing cover can lock air leakage from a filter gap of a heating, ventilation, and air conditioning (HVAC) system. The sheet of impermeable material is provided with a linear opening for a filter to pass through. The zipper is arranged on the sheet. The zipper is located at the linear opening to open and seal the linear opening. The bonding layer is arranged on one side of the sheet for connecting the system; the bonding layer surrounds the linear opening. The filter sealing cover can be install on HVAC systems by the bonding layer. The zipper can be unzipped to change the filter. The way to change the filter is simply and easy.

### TECHNICAL FIELD

The present disclosure relates to a field of the heating, ventilation and air conditioning system, and in particular to a filter sealing cover.

### BACKGROUND

Air leakage often happens in the heating, ventilation and air conditioning (HVAC) system. Air leakage causes the insufficient delivery of air flow and consumes more energy. At the same time, it produces dust and allergens.

Some products have been made to lock the air leakage from filter gap. However, they are not user-friendly and have to use on certain material conditions. For example, FilterLock filter slot seal is a cover with magnetic attachment. It has at least two disadvantages. Firstly, it is not user-friendly. When changing the filter, the whole product has to be taken off and put back again. Moreover, it only can be installed on ferromagnetism materials and cannot be sealed properly at the end.

### SUMMARY

According to various embodiments of the present disclosure, a filter sealing cover is provided.

A filter sealing cover for locking air leakage from a filter gap of a heating, ventilation, and air conditioning system, the filter sealing cover comprising:
a sheet of impermeable material; the sheet is provided with a linear opening for a filter to pass through;
a zipper arranged on the sheet; the zipper is located at the linear opening to open and seal the linear opening; and
a bonding layer arranged on one side of the sheet for connecting the system; the bonding layer surrounds the linear opening.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 illustrates a front view of a filter sealing cover according to an embodiment of the present disclosure;

FIG. 2 illustrates a back view of the filter scaling cover shown in FIG. 1;

FIG. 3 illustrates an exploded view showing the interaction of the filter sealing cover with a piece of HVAC system.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

In order to understand this application thoroughly, detailed steps and structures will be provided in the description below to explain the technical solution proposed by this application. Preferred embodiments of this application are described in detail below. However, in addition to these details, there may be other embodiments of this application.

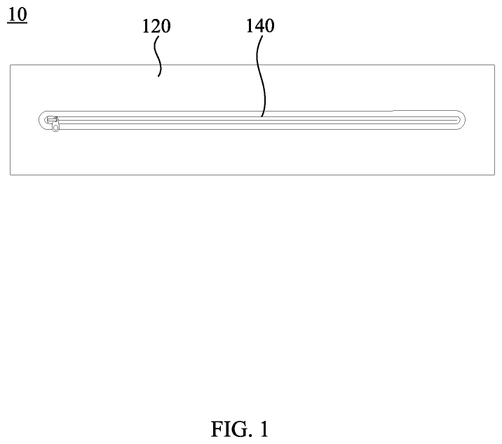

Referring to FIGS. 1-3, a filter sealing cover 10 comprises a sheet 120 of impermeable material, a zipper 140 and a bonding layer 160. The filter sealing cover 10 can lock air leakage from a filter gap of a heating, ventilation, and air conditioning (HVAC) system 20. The sheet 120 of impermeable material is provided with a linear opening 122 for a filter 220 to pass through. In an embodiment, the impermeable material can be polyester fabric. The linear opening 122 can be a slit. The zipper 140 is arranged on the sheet 120. The zipper 140 is located at the linear opening 122 to open and seal the linear opening 122. The bonding layer 160 is arranged on one side of the sheet 120 for connecting the system 20. The bonding layer 160 surrounds the linear opening 122.

HVAC systems 20 usually comprises filters 220 which are detachable for cleaning or replacement. There is a gap between the filter 220 and the main body of the HVAC system 20. Air leakage often happens in the gap. Air leakage can cause the insufficient delivery of air flow, consume more energy, and produce dust and allergens. This filter sealing cover 10 can prevent air leakage from a filter gap in a HVAC system 20 and enhance the air flow of the HVAC system 20. The HVAC system 20 can be used in buildings, cars and other relatively environment. The filter sealing cover 10 can improve air quality from stopping the dust, germ and other allergens enter the houses or cars.

In some embodiments, the zipper 140 can be a seamless laminated zipper 140. The seamless laminated zipper 140 has good sealing and is easy to install on the sheet 120 of impermeable material. The zipper 140 can comprise a slider and two rows of teeth. The slider is mounted on the two rows of teeth. The two rows of teeth are designed to interlock and thereby join the material to which the rows are attached.

In some embodiments, the bonding layer 160 comprises an adhesive tape. The width of the adhesive tape can be at least 25 mm and the adhesive tape can be located at the edge of the sheet 120 to ensure strong connection. In a detailed embodiment, the adhesive tape is a 3M double side adhesive sticker.

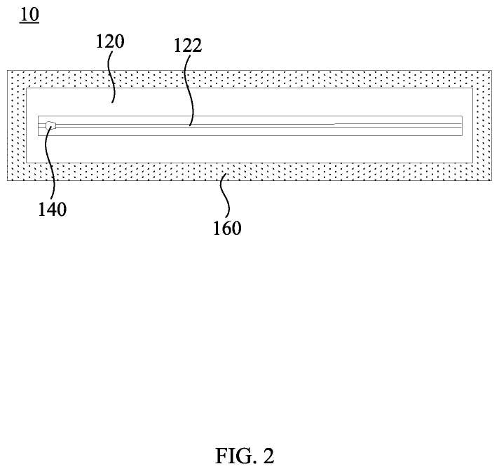

Referring to FIGS. 1-2, in an embodiment, the shape of the sheet 120 can be a rectangle, and the linear opening 122 extends along length of the sheet 120. In some embodiments, the length of the linear opening 122 can be 400 mm-800 mm, such as 600 mm. The sizes of the filter sealing cover 10 can be 63.5 cm×12 cm and 53 cm×12 cm, which can cover most market filter 220 sizes.

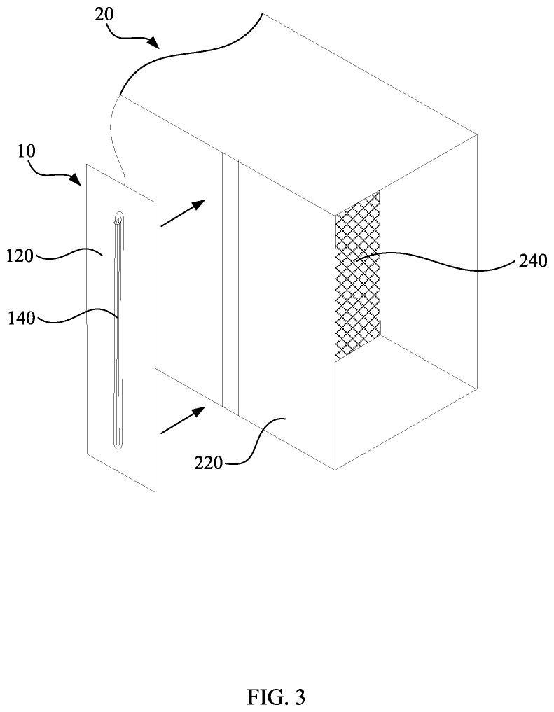

Referring to FIG. 3, the filter sealing cover 10 can be install on any material surface. The bonding layer 160 has adhesiveness and can be used to affix the filter sealing cover 10 to the pipe 240 of the HVAC systems 20. When changing the filter 220, an operator just needs to unzip the zipper 140. The way to change the filter 220 is simply and easy.

The filter sealing cover 10 has advantages over a general filter slot cover with magnetic attachment.

Firstly, the general filter slot cover with magnetic attachment only can be installed on ferromagnetism materials. The filter sealing cover 10 in the embodiment can be installed on any materials by bonding layer 160.

Secondly, the general filter slot cover with magnetic attachment cannot seal properly at the end. The filter sealing cover 10 in the embodiment can apply on any materials and seal completely.

Further, the general filter slot cover with magnetic attachment is not user-friendly. When changing the filter 220, the whole product has to be taken off and put back again. The filter sealing cover 10 in the embodiment can be simply and easily unzipped to load and unload the filter 220. That means the filter sealing cover 10 is much more user-friendly.

Overall, technically, the filter sealing cover 10 can improve the user experience by unzipping the filter sealing cover 10 to change the filter 220. Functionally, the filter sealing cover 10 can improve the top and bottom cover problem, as magnets product cannot cover the filter gap completely.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure. Therefore, the protection scope of the disclosure is subject to the protection scope of the appended claims.

What is claimed is:

1. A filter sealing cover for locking air leakage from a filter gap of a heating, ventilation, and air conditioning system, the filter sealing cover comprising:
a sheet of impermeable material; the sheet is provided with a linear opening for a filter to pass through;
a zipper arranged on the sheet; the zipper is located at the linear opening to open and seal the linear opening; and
a bonding layer arranged on one side of the sheet for connecting the system; the bonding layer surrounds the linear opening.

2. The filter sealing cover as in claim 1, wherein the impermeable material is polyester fabric.

3. The filter sealing cover as in claim 1, wherein the zipper is a seamless laminated zipper.

4. The filter sealing cover as in claim 1, wherein the bonding layer comprises an adhesive tape.

5. The filter sealing cover as in claim 4, wherein width of the adhesive tape is at least 25 mm.

6. The filter sealing cover as in claim 4, wherein the adhesive tape is located at the edge of the sheet.

7. The filter sealing cover as in claim 4, wherein the adhesive tape is a 3M double side adhesive sticker.

8. The filter sealing cover as in claim 1, wherein shape of the sheet is a rectangle, the linear opening extends along length of the sheet.

9. The filter sealing cover as in claim 8, wherein length of the linear opening is 400 mm-800 mm.
